(19) United States
(12) Patent Application Publication
(10) Pub. No.: US 2013/0014510 A1
(43) Pub. Date: Jan. 17, 2013

(54) COATED GAS TURBINE COMPONENTS

(71) Applicant: Christopher M. Pater, Tolland, CT (US)

(72) Inventor: Christopher M. Pater, Tolland, CT (US)

(73) Assignee: UNITED TECHNOLOGIES CORPORATION, Hartford, CT (US)

(21) Appl. No.: 13/184,136

(22) Filed: Jul. 15, 2011

(51) Int. Cl. F02C 3/14

(52) U.S. Cl. 60/752

(57) ABSTRACT

A gas turbine component subject to extreme temperatures and pressures includes a wall defined by opposite first and second surfaces. An airflow aperture through the wall is defined by an aperture wall surface which extends from a first opening in the first surface to a second opening in the second surface. The aperture wall surface is flared at a juncture with the first surface, such that the first opening has a greater cross-sectional flow area than the second opening. A high-pressure, high-temperature coating is adhered to the first surface, and adhered to at least a portion of the aperture wall surface.

### BACKGROUND

The present invention relates generally to coated gas turbine components, and more particularly components having airflow apertures and protective coatings.

Combustion chambers are engine sections which receive and combust fuel and high pressure gas. Gas turbine engines utilize at least one combustion chamber in the form of a main combustor which receives pressurized gas from a compressor, and expels gas through a turbine which extracts energy from the resulting gas flow. Some gas turbine engines utilize an additional combustion chamber in the form of an afterburner, a component which injects and combusts fuel downstream of the turbine to produce thrust. All combustion chambers, including both main-line combustors and afterburners, are constructed to withstand high temperatures and pressures.

Combustion chambers and other high-temperature gas turbine components vary greatly in geometry depending on location and application. All combustion chambers comprise a plurality of walls or tiles which guide and constrain gas flow, typically including a liner which surrounds a combustion zone within the combustion chamber. Liners and some other combustion chamber walls are conventionally ventilated with numerous air holes or apertures for cooling. Conventional apertures for this purpose are holes with walls normal to the surface of the liner. Some combustion chamber walls, including liners for main-line combustors and afterburners, receive thermal barrier coatings, coatings for erosion prevention, or radar absorbent coatings to reduce the radar profile of exposed portions of the turbine. Such coatings must withstand exceptionally high temperatures and pressures, and are frequently formed of brittle ceramics which are vulnerable to fracturing and delamination. Coatings in other high-temperature, high-pressure areas of gas turbines, particularly on combustor nozzles and hot turbine blades and vanes, share similar design requirements.

According to some prior art techniques, cooling apertures have been bored or punched in combustion chamber walls after coating deposition. More recent techniques apply coatings to combustion chamber walls and other gas turbine components after the formation of apertures. When using either technique, coatings near apertures are especially vulnerable to mechanical stresses, and are prone to fracture, ablate and delaminate from the substrate combustion chamber wall. A design solution is needed which reduces the stresses on combustion chamber wall coatings at aperture locations.

### SUMMARY

The present invention is directed toward a gas turbine component subject to extreme temperatures and pressures. The gas turbine component includes a wall defined by opposite first and second surfaces. An airflow aperture through the wall is defined by an aperture wall surface which extends from a first opening in the first surface to a second opening in the second surface. The aperture wall surface is flared at a juncture with the first surface, such that the first opening has a greater cross-sectional flow area than the second opening. A high-pressure, high-temperature coating is adhered to the first surface, and adhered to at least a portion of the aperture wall surface.

### BRIEF DESCRIPTION OF THE DRAWINGS

FIG. 1 is a schematic view of a gas turbine engine.

FIGS. 2A, 2B, 2C, and 2D are cross-sectional views of cooling apertures in an engine combustion chamber wall of FIG. 1.

FIG. 3 is a cross-sectional view of the cooling aperture of FIG. 2B, illustrating relevant geometry.

FIG. 4 is a cross-sectional view of the cooling aperture of FIG. 2C, illustrating relevant geometry.

FIGS. 5A, 5B, and 5C are simplified cross-sectional views illustrating formation of the cooling aperture of FIG. 2A using a rotary machine tools.

### DETAILED DESCRIPTION

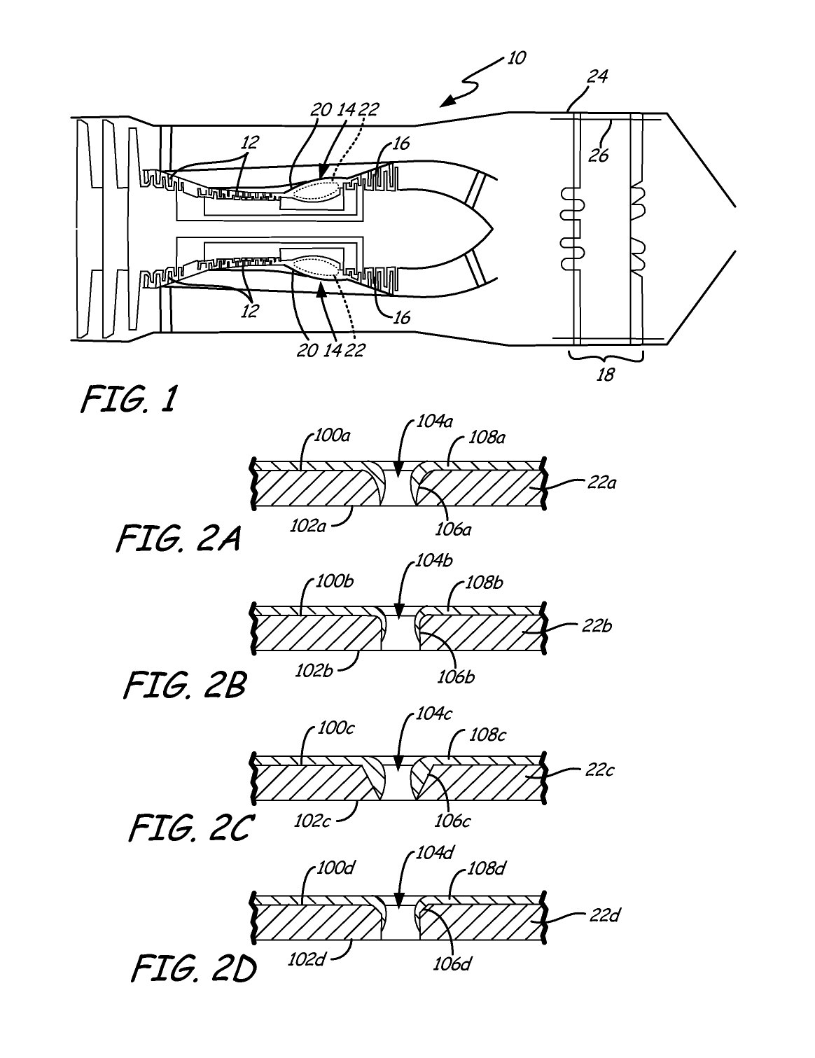

FIG. 1 is a schematic view of gas turbine engine 10, comprising compressor 12, combustor 14, turbine 16, and afterburner 18. Combustor 14 has combustor outer wall 20 and combustor liner 22, and afterburner 18 has afterburner outer wall 24 and afterburner liner 26. Compressor 12 receives and pressurizes environmental air, and delivers this pressurized air to combustor 14. Combustor 14 injects fuel into this pressurized air, and ignites the resulting fuel-air mixture. Turbine 16 receives gas flow from combustor 14, and extracts much of the kinetic energy of this airflow to power compressor 12 and other systems, potentially including an electrical generator (not shown). Exhaust from turbine 16 passes through afterburner 18, wherein additional fuel is injected, and the resulting fuel-air mixture ignited to produce thrust.

Combustor outer wall 20 is a first rigid heat-resistant barrier which defines the outer extent of combustor 14. Combustor liner 22 is a second rigid heat-resistant barrier, such as of nickel alloy, with a plurality of cooling apertures, as described with respect to FIGS. 2A-2D. These cooling apertures supply a thin film of cooling air to the interior of combustor liner 22.

The operation of afterburner 18 largely parallels the operation of combustor 14. Afterburner outer wall 24 and afterburner liner 26 are rigid heat-resistant barriers, and afterburner liner 26 features a plurality of cooling apertures, like combustor liner 22. These apertures provide a film of cooling air to the interior of afterburner liner 26, where fuel is injected and combusted to provide additional thrust.

Combustor liner 22 and afterburner liner 26 receive coatings such as thermal barrier coatings. These coatings must withstand extreme temperatures and pressures for extended periods. To improve the adhesion of these coatings to combustor liner 22 and afterburner liner 26 in such high temperatures and pressures, apertures in combustor liner 22 and afterburner liner 26 are formed in geometries described below with respect to FIGS. 2A-2D to increase the aperture wall surface area on which coating is deposited and to reduce stress in the coating that can lead to failure of the coating at or near the apertures.

FIGS. 2A, 2B, 2C, and 2D depict various embodiments of aperture 104 (i.e. apertures 104a, 104b, 104c, and 104d) in combustor liner 22. Although description is provided in terms of combustor liner 22, it will be understood by those skilled in the art that apertures 104a, 104b, 104c, and 104d may be cooling holes in any appropriate combustion chamber wall, such as afterburner liner 26.

FIG. 2A depicts one embodiment of combustor liner 22. Although description hereinafter will focus on apertures in combustor liner 22 (see FIG. 1), those skilled in the art will recognize that the aperture geometries disclosed herein may be utilized for cooling holes in afterburner liner 26, or in other coated high-temperature and high-pressure gas turbine structures, such as in coated airfoil blade or vane surfaces, nozzle flaps, or nozzle seals. FIG. 2A shows combustor liner 22a having first surface 100a and second surface 102a interrupted by aperture 104a. First surface 100 and second surface 102 define opposite sides of combustor liner 22a. First surface 100a may, for instance, be an inner surface of combustor liner 22, and second surface 102a may, for instance, be an outer surface of combustor liner 22.

Aperture 104a is a cooling hole extending through liner 22a along an axis normal to liner first surface 100a. Aperture 104a is defined and bounded in liner 22a by aperture wall surface 106a. Aperture wall surface 106a spans between first surface 100a and second surface 102a. Coating 108a is deposited atop first surface 100a, and infiltrates aperture 104a to at least partially cover aperture wall surface 106a, as shown. Coating 108 is a high-temperature and high-pressure resistant coating such as a ceramic-based plasma spray coating. Aperture 104a may be a cooling hole through combustor liner 22a. Aperture wall surface 106a may be substantially symmetric across a midpoint of aperture 104a, and is flared where it meets first surface 100a. In particular, aperture wall surface 106a meets first surface 100a in circular, elliptical, or polygonal hole perimeter. Aperture wall surface 106a is angled at a uniform obtuse angle relative to first surface 100a, at this hole perimeter. In particular, aperture wall surface 106a is curved continuously from first surface 100a at this hole perimeter. In other embodiments, aperture wall surface 106a may be sloped, flared, beveled or chamfered at the hole perimeter where it meets first surface 100a, as discussed in further detail below with respect to FIGS. 2B, 2C, and 2D. Aperture 104a thus diverges from a narrow opening at second surface 102a to a wider opening at surface 100a, i.e. an opening with a greater cross-sectional flow area. This curve, slope, flare, bevel, of chamfer at the hole perimeter provides a vector component of aperture wall surface 106a parallel to first surface 100a.

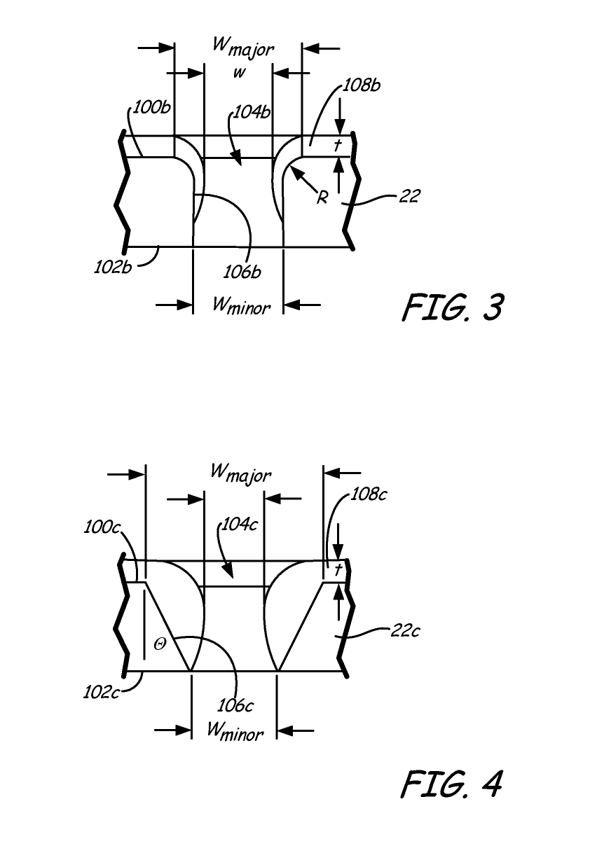

Coating 108a is applied, for example, by physical vapor deposition in a direction normal to first surface 100a, and is thus able to adhere to aperture wall surface 106a. Aperture wall surface 106a has a tapered segment generally contiguous to first surface 100a onto which coating 108a can be deposited inside aperture 104a. The curve (or, alternatively, slope, flare, bevel, or chamfer) at the juncture of aperture wall surface 106a and first surface 100a provides a less abrupt angular transition from first surface 100a to aperture wall surface 106a, dramatically reducing stress on coating 108 around aperture 104a as discussed in detail with respect to FIGS. 3 and 4. In addition, this contour at the juncture of aperture wall surface 106a and first surface 100a allows coating 108a to adhere to at least a portion of aperture wall surface 106a, thereby reduces ablation and delamination of coating 108a near aperture 104a.

FIG. 2B depicts an alternative embodiment of combustor liner 22 (or other coated gas turbine structure, as discussed above). FIG. 2B generally parallels FIG. 2A both in structure and numbering, and depicts similar combustor liner 22b having first surface 100b and second surface 102b interrupted by aperture 104b. Aperture 104b has aperture wall surface 106b, a substantially symmetric surface which, like aperture wall surface 106a, is flared in a continuous curve near first surface 100b, but which is cylindrically shaped near second surface 102b Like aperture wall surface 106a, aperture wall surface 106b diverges from an opening at second surface 102b to a wider opening at first surface 100b, thereby providing a region of aperture wall surface 106b on which coating 108b is deposited. The flared juncture between first surface 100b and aperture wall surface 106b reduces stress on coating 108b at the hole perimeter of aperture 104b by reducing the abruptness of the angular transition between first surface 100b and aperture wall surface 106b, thereby decreasing the chance of ablation or delamination of coating 108b.

FIG. 2C depicts an alternative embodiment of combustor liner 22 (or other coated gas turbine structures, as discussed above). FIG. 2C generally parallels FIGS. 2A and 2B both in structure and numbering, and depicts similar combustor liner 22c having first surface 100c and second surface 102c interrupted by aperture 104c. Aperture wall surface 106c of aperture 104c has a frusto-conical, uncurved cross-sectional profile from first surface 100c to second surface 102c. Like aperture wall surfaces 106a and 106b, aperture wall surface 106c diverges from an opening in second surface 102c to a wider opening in second surface 100c. Similarly to aperture wall surfaces 106a and 106b, aperture wall surface 106c is flared or inclined at a hole perimeter where it meets first surface 100c, thereby providing a less abrupt angular transition from first surface 100c to aperture wall surface 106c which reduces strain on coating 108c and allows coating 108c to adhere to at least a region of aperture wall surface 106c.

FIG. 2D depicts an alternative embodiment of combustor liner 22 (or other coated gas turbine structures, as discussed above). FIG. 2D generally parallels FIGS. 2A, 2B, and 2C in structure and numbering, and depicts similar combustor liner 22d having first surface 100d and second surface 102d interrupted by aperture 104d. Aperture wall surface 106d has a symmetric frusto-conical cross-sectional profile near first surface 100d, and a cylindrical profile near second surface 102d. This chamfer at the junction of first surface 100d and aperture wall surface 106d reduces the abruptness of the angular transition between first surface 100d and aperture wall surface 106d, reducing strain on coating 108d near aperture 104d. Like aperture wall surfaces 106a, 106b, and 106c, the flare of aperture wall surface 106d near first surface 100d allows at coating 108d to be adhered to at least a portion of aperture wall surface 106d, reducing the chance of delamination or ablation of coating 108d near aperture 104d.

FIGS. 3 and 4 illustrate dimensions of apertures 104b and 104c of FIGS. 2B and 2C, respectively. Although apertures 104b and 104c are described as substantially circular holes, one skilled in the art will recognize that the present invention may similarly be applied to elliptical, rectangular, and other polygonal holes.

FIG. 3 illustrates combustor liner 22b with first surface 100b, second surface 102b, coating 108b, and aperture 104b with aperture wall surface 106b. The minimum width of aperture 104b defines minor width Wₘᵢₙₒᵣ, while the maximum width of aperture 104b defines major width Wₘₐⱼₒᵣ, as shown. In the case of a circular hole, Wₘᵢₙₒᵣ and Wₘₐⱼₒᵣ are minimum and maximum diameters of aperture 104b, respectively. Applying coating 108 further reduces the effective aperture width of aperture 104b to flow width w, which corresponds to the usable cross-sectional area of aperture 104b for airflow purposes. Coating 108b has coating thickness t, and aperture wall surface 106b has radius of curvature r. This curvature of aperture wall surface 106b reduces the abruptness of the angular transition from first surface 100b to aperture wall surface 106b, thereby reducing stress on coating 108b relative to flat aperture wall surfaces perpendicular to first surface 100b. As an illustrative example, coating stress k drops by more than a factor of 2 as radius of curvature r approaches coating thickness t:

$$\begin{matrix}For \frac{r}{t} = 0 , k = 2.5 \\ ( cylindrical apertures ) & [ Equation 1 ] \\ For \frac{r}{t} = 1 , k = 1.2 \\ ( aperture 104 b , as r approaches t ) & [ Equation 2 ]\end{matrix}$$

(Young, Warren C., Roark's Formulas for Stress & Strain, 6th Ed.)

As radius of curvature r increases, aperture wall surface 106b approaches aperture wall surface 106a. Larger radii of curvature r reduce strain on coating 108, decreasing the likelihood of coating ablation or delamination.

FIG. 4 parallels FIG. 3, and depicts combustor liner 22c with first surface 100c, second surface 102c, coating 108c, and aperture 104c with aperture wall surface 106c. Aperture wall surface 106c is not curved, but is angled at surface angle Θ relative to normal to first surface 100c. Angle Θ provides a less abrupt angular transition for coating 108 at aperture 104c, introducing an effective nonzero radius of curvature to the transition between first surface 100c and aperture wall surface 106c which reduces coating stress k in a manner qualitatively similar to the stress reduction described above with respect to FIG. 3.

In addition to improving the stress characteristics of coating 108c near apertures, the present invention increases the area of coating adhesion on aperture wall surface 106c. For example, the area of coating adhesion on aperture wall surface 106c of a circular aperture 104c can be expressed as:

$${A}_{adh} = \frac{π}{2 ( {W}_{major} + {W}_{minor} ) \sqrt{\frac{1}{4} {( {W}_{major} - {W}_{minor} )}^{2} + t}} \qquad [ Equation 3 ]$$

The areas of coating adhesion on aperture wall surfaces 106a, 106b, and 106d is similarly increased over prior art cylindrical apertures. This increased adhesion area reduces the likelihood of ablation or delamination of coating 108c.

Flow width w is predictable from coating thickness t and the geometry of aperture 104. For a circular aperture 104c:

$$w = \frac{{W}_{major} - {W}_{minor}}{2} - 2 t sin Θ \qquad [ Equation 4 ]$$

A desired flow width w can be produced by selecting an appropriate deposition rate of coating 108c and appropriate dimensions for aperture 104c. In this way, aperture 104c can be constructed with desired cross-sectional area for cooling airflow. Flow width w is similarly predictable for apertures 104a, 104b, and 104d.

Aperture wall surface 106c is flared where it meets first surface 100c. This geometry provides area for coating 108 to adhere to aperture wall surface 106c, reducing strain on coating 108c near apertures 104c. Aperture wall surfaces 106a, 106b, and 106d reduce coating strain analogously.

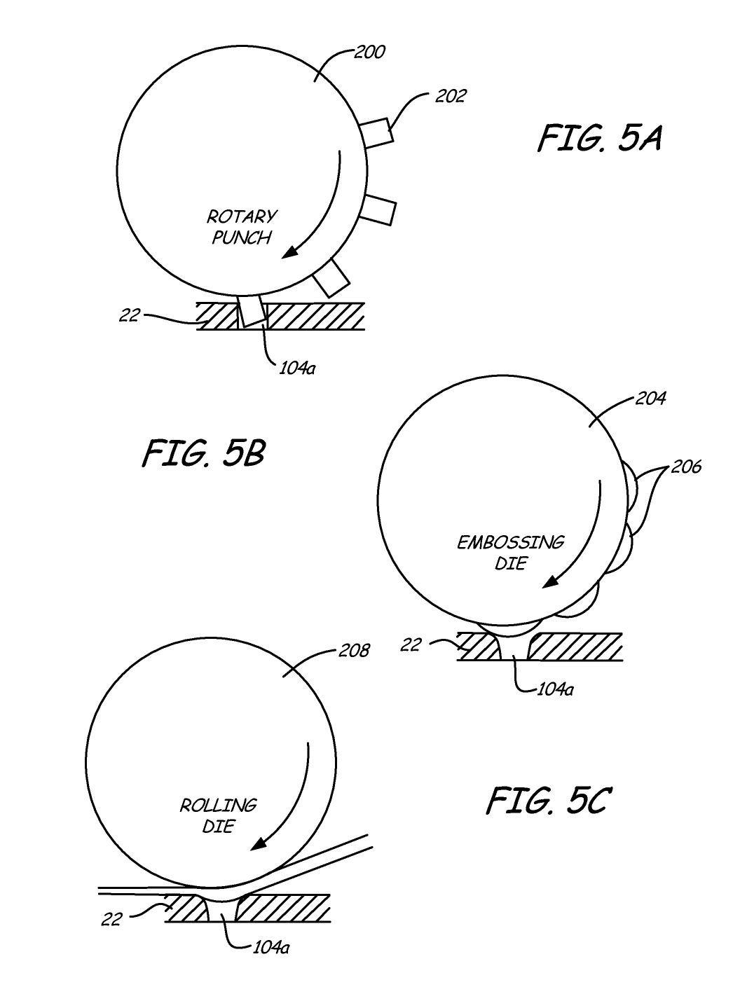

FIGS. 5A, 5B, and 5C depict possible steps in the formation of aperture 104a. These steps can alternatively be used to fabricate apertures 104b, 104c, or 104d. Apertures can generally be formed by a variety of methods, including casting, machine stamping, electrodischarge machining, and laser boring. FIGS. 5A, 5B, and 5C depict only a few possible fabrication methods.

FIG. 5A depicts rotary punch 200 and combustor liner 22. Rotary punch 200 is a rotating machining tool with punch heads 202. Punch heads 202 punch holes through combustor liner 22 as a first step in formation of apertures 104a. Punch heads 202 may be circular, elliptical, rectangular, or other polygonal punches, and may have widths or diameters selected to produce desired dimensions of apertures 104a, such as minor width Wₘᵢₙₒᵣ. As rotary punch 200 turns, punch heads 202 rotate one by one into alignment with desired locations for apertures 104a. Punch heads 202 then press through combustor liner 22, punching out sections corresponding to apertures 104a.

FIG. 5B depicts embossing die 204 and combustor liner 22. Embossing die 204 is a rotating machining tool with embossing posts 206. Embossing posts 206 emboss combustor liner 22 at the locations of holes formed by rotary punch 200. Embossing posts 206 turn into position with locations of apertures 104a, and press into combustor liner 22 to mold holes formed by rotary punch 200 into the desired geometry of apertures 104a (or, alternatively, any other aperture of the present invention, such as 104b, 104c, or 104d).

FIG. 5C depicts rolling die 208, ductile sheet stock 210, and combustor liner 22. As an alternative to embossing die 204, rolling die 208 can be used to mold holes formed by rotary punch 200 into the desired geometry of apertures 104a (or other aperture geometries). Rolling die 208 is a rotating machining tool which presses ductile sheet stock 210 against combustor liner 22 at the locations of holes formed by rotary punch 100. Ductile sheet stock 210 is a sheet of consumable ductile material through which rolling die 208 applies pressure to deform combustor liner 22 into a desired shape.

The formation of apertures 104a, 104b, 104c, and 104c may require applications of a combination of rotary punch 200, embossing die 204, and rolling die 208. Aperture 104a may, for instance, be formed by iteratively punching and embossing combustor liner 22 using a variety of rotary punches 200 and embossing dies 204. Aperture 104a is formed over multiple such iterations, such that aperture wall surface 106a of resulting aperture 104a converges from an opening at first surface 100a to narrower opening at second surface 102a (see FIG. 2A).

Aperture geometries of the present invention, such as illustrated in FIGS. 2A-2D, provide increased substrate adhesion area as compared to the prior art, and significantly reduce stress on coating 108. In addition, these geometries allow airflow width w to be precisely controlled during machining of apertures 104 and deposition of coating 108 to produce a desired cross-sectional flow area.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A gas turbine engine component subject to extreme temperatures and pressures, the gas turbine engine component comprising:
a wall having a first surface and a second surface which define opposite sides of the wall, and an airflow aperture that extends through the wall in a direction generally perpendicular to the first surface, the airflow aperture defined by an aperture wall surface which extends from a first opening in the first surface to a second opening in the second surface, and which is flared at a juncture with the first surface such that the first opening has a greater cross-sectional flow area than the second opening; and
a high-pressure, high-temperature resistant coating adhered to the first surface, and adhered to a portion of the aperture wall surface adjacent the first opening.

2. The gas turbine engine component of claim 1, wherein the gas turbine engine component is a gas turbine combustor liner or afterburner liner.

3. The gas turbine engine component of claim 1, wherein the gas turbine engine component is an airfoil blade or vane.

4. The gas turbine engine component of claim 1, wherein the aperture wall surface adjacent the second surface is substantially perpendicular to the first and second surfaces.

5. The gas turbine engine component of claim 1, wherein the coating is adhered in a uniform thickness.

6. The gas turbine engine component of claim 5, wherein the portion of the aperture wall surface adjacent the first surface has cross-sectional profile with a radius of curvature greater than or equal to the uniform thickness of the coating.

7. The gas turbine engine component of claim 1, wherein the portion of the aperture wall surface adjacent the first surface has a substantially frusto-conical cross-sectional profile.

8. The gas turbine engine component of claim 7, wherein the aperture wall surface has a frusto-conical cross-sectional profile from the first surface to the second surface.

9. The gas turbine engine component of claim 1, wherein the coating is a ceramic-based protective coating.

10. The gas turbine engine component of claim 1, wherein the first and second openings are substantially circular.

11. The gas turbine engine component of claim 1, wherein at least one of the first or second openings is elliptical.

12. A gas turbine engine component subject to extreme temperatures and pressures, the gas turbine engine component comprising:
a wall having a first surface and a second surface which define opposite sides of the wall, and an airflow aperture that extends entirely through the wall, the airflow aperture defined by an aperture wall surface which meets the first surface in a hole perimeter, such that the aperture wall surface is angled at a uniform obtuse angle relative to the first surface at this hole perimeter; and
a high-pressure, high-temperature resistant coating adhered to the first surface, and adhered to a portion of the aperture wall surface adjacent the first opening.

13. The gas turbine engine component of claim 12, wherein the wall is a gas turbine engine combustor liner or afterburner liner.

14. The gas turbine engine component of claim 12, wherein the wall is an airfoil blade or vane surface.

15. The gas turbine engine component of claim 12, wherein the high-pressure, high-temperature resistant coating comprises a ceramic-based plasma spray coating.

16. The gas turbine engine component of claim 15, wherein the ceramic-based coating is a thermal barrier coating.

17. The gas turbine engine component of claim 12, wherein the aperture wall surface has a substantially frusto-conical cross-section at the hole perimeter.

18. The gas turbine engine component of claim 12, wherein the aperture wall surface is curved continuously with the first surface at the hole perimeter.

19. The gas turbine engine component of claim 12, wherein the hole perimeter is elliptical.

20. The gas turbine engine component of claim 12, wherein the aperture wall surface adjacent the second surface is substantially perpendicular to the first and second surfaces.
